(19) United States
(12) Patent Application Publication
(10) Pub. No.: US 2016/0079634 A1
(43) Pub. Date: Mar. 17, 2016

(54) ALL-SOLID-STATE BATTERY AND METHOD FOR PRODUCING THE SAME, AND METHOD FOR RESTORING CAPACITY OF THE SAME

(71) Applicant: HITACHI, LTD., Tokyo (JP)

(72) Inventors: Taigo ONODERA, Tokyo (JP); Jun KAWAJI, Tokyo (JP)

(73) Assignee: HITACHI, LTD., Tokyo (JP)

(21) Appl. No.: 14/690,527

(22) Filed: Apr. 20, 2015

(30) Foreign Application Priority Data
Sep. 12, 2014 (JP) 2014-185847

(51) Int. Cl. H01M 10/42; H01M 4/04; H01M 4/139; H01M 10/0562

(52) U.S. Cl. CPC H01M 10/4214; H01M 10/0562; H01M 4/0471; H01M 4/139; H01M 2300/0071

(57) ABSTRACT

The all-solid-state battery according to the present invention includes a cathode, an anode, a solid electrolyte layer disposed between the cathode and the anode, wherein at least one of the cathode and the anode contains a solid electrolyte having deliquescence, and the all-solid-state battery includes a water supply and removal section that supplies water to an electrode containing the solid electrolyte having deliquescence and discharges water in the electrode to the outside of the battery.

### BACKGROUND OF THE INVENTION

1. Field of the Invention

The present invention relates to an all-solid-state battery and a method for producing the same, and a method for restoring capacity of an all-solid-state battery.

2. Description of the Related Art

In recent years, a portable personal computer, information communication devices such as a mobile telephone terminal, household storage system, hybrid automobile, electric automobile and the like which use a secondary battery as a power source become popular. A lithium ion secondary battery, one of the secondary batteries, is a battery having a high energy density, as compared to other secondary batteries such as a nickel hydrogen storage battery. However, the lithium ion secondary battery uses a flammable organic solvent as a liquid electrolyte, thus, in order to prevent ignition and burst sometimes caused by overcurrent due to short circuit and the like, installation of a safety device may be necessary. Also, in order to prevent the above phenomena, it may be restricted on selection of the battery materials and design of the battery structure.

Therefore, in place of a liquid electrolyte, an all-solid-state battery using a solid electrolyte has been developed. The all-solid-state battery does not contain a flammable organic solvent, thus has an advantage that a safety device can be simplified, and is recognized as a battery excellent in production cost and productivity. In addition, it is easy to stack a joining structure composed of a pair of electrodes composed of a cathode and an anode and a solid electrolyte layer interposed between these electrodes in series, thus the all-solid-state battery is expected as a technology that can produce a battery having a high capacity and a high output while it is stable.

In the all-solid-state battery, it is known that contact resistance between active material particles taking charge of battery reaction and between the active material particles and the solid electrolyte particles greatly affects the internal resistance of the battery. Particularly, it is known that, due to the volume change of the active material with a repeat of charge and discharge, a contact property between the active material and the solid electrolyte, a conductive agent or the like is lowered, and increase in internal resistance, reduction in capacity or the like are occurred, thus charge/discharge cycle characteristics are deteriorated. Thus, a technology for suppressing increase in internal resistance due to charge/discharge cycle and the like is suggested.

For example, JP-2013-222530-A discloses an all-solid-state battery in which a current and a voltage during charging and discharging are properly controlled, in order to improve charge/discharge cycle characteristics.

In addition, JP-2013-206790-A discloses an all-solid-state battery in which an aluminum metal is filled into a porous part of a solid powder molded body composed of an active material and a solid electrolyte by plating, in order to improve charge/discharge cycle characteristics.

### SUMMARY OF THE INVENTION

In an all-solid-state battery, it is difficult to fundamentally solve interfacial delamination between an active material and an active material, and between an active material and a solid electrolyte in expansion and contraction of active material particles at charge/discharge cycle. In JP-2013-222530-A charge/discharge cycle characteristics are improved by reducing interfacial delamination between particles occurred during charging and discharging. However, in an all-solid-state battery, further improvement in charge/discharge cycle characteristics is necessary. In JP-2013-206790-A, increase in internal resistance and reduction in charge/discharge capacity can be suppressed, and it is required to further decrease internal resistance of the battery increased with charge/discharge cycle, and suppress reduction in charge/discharge capacity.

Therefore, an object of the present invention is to provide an all-solid-state battery in which charge/discharge cycle characteristics are improved by restoring reduced charge/discharge capacity.

In order to solve the above problems, the all-solid-state battery according to the present invention includes a cathode, an anode, and a solid electrolyte layer disposed between the cathode and the anode, wherein at least one of the cathode and the anode contains a solid electrolyte having deliquescence, and the all-solid-state battery includes a water supply and removal section that supplies water to an electrode containing the solid electrolyte having deliquescence and removes water in the electrode.

According to the present invention, an all-solid-state battery in which charge/discharge cycle characteristics are improved can be provided.

### BRIEF DESCRIPTION OF THE DRAWINGS

FIG. 1 is a cross-sectional view schematically showing an example of a constitution of the all-solid-state battery according to the present embodiment;

FIG. 2 is a cross-sectional view schematically showing an example of a constitution of the bipolar all-solid-state battery according to the present embodiment; and

FIG. 3 is a diagram showing the evaluation result of charge/discharge cycle characteristics of the all-solid-state battery according to the present embodiment.

### DESCRIPTION OF THE PREFERRED EMBODIMENTS

Hereinbelow, the all-solid-state battery according to an embodiment of the present invention and electrodes for an all-solid-state battery will be described in detail. The all-solid-state battery according to the present embodiment is a battery in which a solid electrolyte mediates ion carrier conduction between the electrodes, and the electrodes relate to a bulk all-solid-state battery mainly formed by aggregation of active material particles. This all-solid-state battery mainly includes a pair of electrodes composed of a cathode and an anode and a solid electrolyte layer interposed between the cathode and the anode. Moreover, at least one of the cathode and the anode contains an active material and a solid electrolyte having deliquescence. The solid electrolyte herein refers to a solid ion conductor, and is a material that serves as a medium urging movement of ions to be a carrier of the secondary battery. The all-solid-state battery according to the present embodiment includes a water supply and removal section that supplies water to at least one of the cathode and the anode and removes water of at least one of the cathode and the anode.

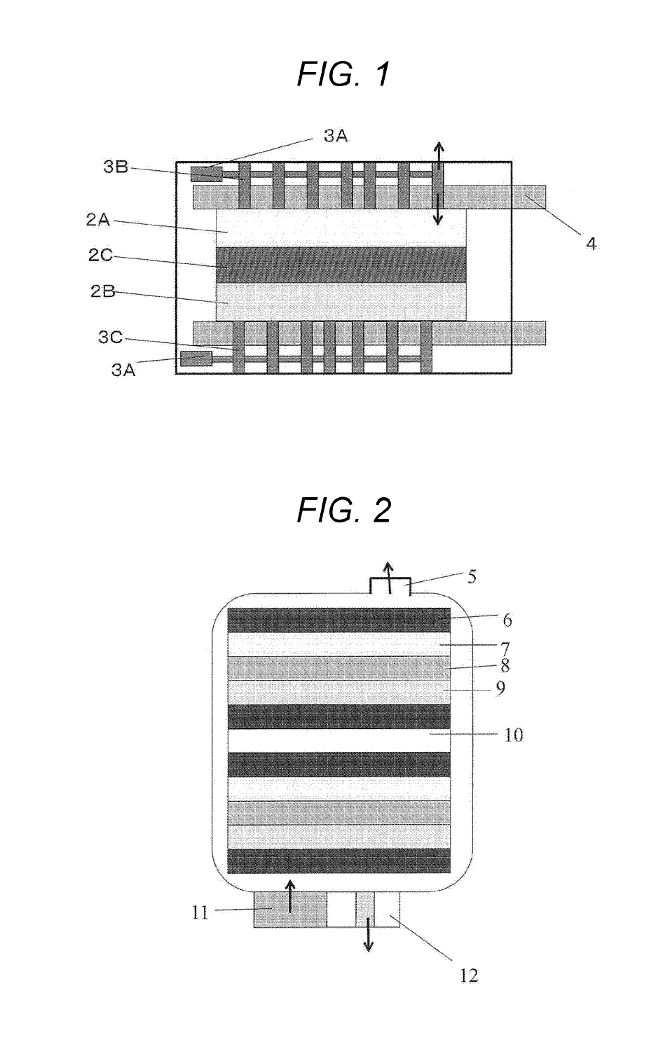

FIG. 1 is a cross-sectional view schematically showing an example of a constitution of the all-solid-state battery according to the present embodiment. All-solid-state battery 1 has cathode 2A, anode 2B, and solid electrolyte layer 2C. The cathode 2A, the anode 2B and the solid electrolyte layer 2C are laminated so as to interpose the solid electrolyte layer 2C between the cathode 2A and the anode 2B. In the all-solid-state battery 1, both cathode 2A and anode 2B contain an active material and a solid electrolyte, and the all-solid-state battery 1 contains a water supply tank and a water supply and removal flow path as a water supply and removal section. Water supply to the cathode is carried out from water supply tank 3A via cathode side water supply and removal flow path 3B, and water supply to the anode is carried out from the water supply layer via anode side water supply and removal flow path 3C. In addition, water removal in the all-solid-state battery is also carried out via the cathode side water supply and removal flow path 3B and the anode side water supply and removal flow path 3C.

### <Electrode>

At least one of the cathode and the anode contains a solid electrolyte having deliquescence. The solid electrolyte having deliquescence is filled between active materials, an interface between an active material particle and an active material particle, and between an active material particle and a solid electrolyte particle is delaminated by charge/discharge cycle. Even when capacity is reduced, water is supplied to the cathode or the anode from the water supply and removal flow path, and a deliquescent solid electrolyte is again allowed to deliquesce, then excess water is removed, whereby the delaminated interface can be reconstructed. The delaminated interface is reconstructed, thereby reducing internal resistance, and the capacity can be restored. As a result, it is possible to improve charge/discharge cycle characteristics.

The phrase “having deliquescence” herein refers to have a deliquescent property in a normal temperature range (0° C. or more and 100° C. or less) in the atmosphere. The solid electrolyte having deliquescence is used in the production of an electrode in the all-solid-state battery, whereby it is possible to form a matrix structure in which the solid electrolyte is filled at a high density in the gap between particles of the active material constituting the electrode. Moreover, the solid electrolyte is filled at a high density in the gap between particles of the active material constituting the electrode, whereby the particles of the active material come into contact through a wider area of the solid electrolyte, not only a point contact.

In addition, it is preferred that the solid electrolyte having deliquescence is contained in both the cathode and the anode. It is because both the cathode and the anode are likely to cause interfacial delamination by expansion and contraction of the active material by charging and discharging.

The content of the solid electrolyte having deliquescence in the electrode is different depending on the particle size and type of the active material. It is considered that, as the particle size of the active material is large, the gap between the active materials is increased, thus the content of the deliquescent solid electrolyte is preferably increased. This shall not apply in the case where the active materials with a plurality of particle sizes are used for the electrode, and the like.

Examples of the solid electrolyte having deliquescence include vanadium oxides and sulfide solid electrolyte materials. The vanadium oxide includes lithium vanadium oxides, in the case where a carrier taking charge of battery reaction is a lithium ion. The lithium vanadium oxide has the conductivity of lithium ion. The ion conductivity of the lithium vanadium oxide is preferably 1×10⁻⁶ S/cm or more and more preferably 1×10⁻⁶ S/cm or more. When the ion conductivity of the lithium vanadium oxide is 1×10⁻⁶ S/cm or more, the ion conductivity between the active material particles and between the active material and the solid electrolyte can be significantly improved by the lithium vanadium oxide filled between the active material particles. Thus, it is possible to favorably reduce internal resistance in the battery and secure higher discharge capacity. The ion conductivity herein is the value at 20° C.

Also, the lithium vanadium oxide has a conductivity of electrons generated by battery reaction. Specifically, the electron conductivity of the lithium vanadium oxide is preferably 1×10⁻⁸ S/cm or more and more preferably 1×10⁻⁶ S/cm or more. When the electron conductivity of the lithium vanadium oxide is 1×10⁻⁸ S/cm or more, the electron conductivity between the active material particles and between the active material and the lithium vanadium oxide can be significantly improved by the lithium vanadium oxide filled between the active material particles. Thus, it is possible to favorably reduce internal resistance in the all-solid-state battery and secure higher discharge capacity. The electron conductivity herein is the value at 20° C.

The lithium vanadium oxide exists by forming a crystal in the electrode in the all-solid-state battery. The electrode of the produced all-solid-state battery is usually in an environment separated from water, thus the lithium vanadium oxide is deposited in the gap between the active material particles as a crystal, not in a deliquescent state, and the electron conductivity and ion conductivity between the active material particles are favorably secured.

The lithium vanadium oxide specifically includes Li₄V₁₀O₂₇, Li_{1.5}V₂O₄, Li_{0.9}V₂O₄, Li₃VO₄, LiV₂O₅, Li_{1.11}V₃O_{7.89}, LiVO₂, Li_{6.1}V₃O₈, LiV₂O₄, Li_{0.2}V_{1.16}O₂, Li_{0.19}VO₂, LiV₃O₈, LiVO₃ and the like. In the present invention, a material containing a lithium vanadium oxide with a LiVO₃ structure having a lattice constant different from that of deliquescent LiVO₃ also has high ion conductivity and electron conductivity as the lithium vanadium oxide, thus it is possible to favorably reduce internal resistance in the all-solid-state battery and secure higher discharge capacity. Among them, easily deliquescent LiVO₃ is particularly preferable.

It is preferred that the solid electrolyte having deliquescence is a lithium vanadium oxide better than a sulfide solid electrolyte material. It is because that the lithium vanadium oxide is not likely to generate a harmful substance such as hydrogen sulfide as a sulfide solid electrolyte.

As the active material used in the all-solid-state battery of the present invention, active materials used in a general all-solid-state battery can be used for each of a cathode and an anode. For example, when the all-solid-state battery is a primary battery, an active material absorbing lithium ions is used in the electrode, and when the all-solid-state battery is a secondary battery, an active material having electrochemical activity reversibly intercalating and deintercalating lithium ions is used in the electrode.

As the cathode active material contained in the cathode, when the carrier is a lithium ion, for example, lithium transition metal oxides such as olivine type such as lithium manganese phosphate (LiMnPO₄), lithium iron phosphate (LiFePO₄) and cobalt iron phosphate (FeCoPO₄), layered type such as lithium cobaltate (LiCoO₂), lithium nickelate (LiNiO₂), lithium manganese(III) dioxide (LiMnO₂), and layered type such as ternary oxides represented as LiNiₓCo_{y}Mn_{z}O₂ (wherein 0≦x≦1, 0≦y≦1, 0≦z≦1, and x+y+z=1), spinel type such as lithium manganese (LiMn₂O₄), and polyanion type such as lithium vanadium phosphate (Li₃V₂(PO₄)₃) can be used. In addition, when the carrier is a sodium ion, for example, sodium iron oxide (NaFeO₂), sodium cobaltate (NaCoO₂), sodium nickelate (NaNiO₂), sodium manganese(III) dioxide (NaMnO₂), sodium vanadium phosphate (Na₃V₂(PO₄)₃), sodium vanadium fluorophosphate (Na₃V₂(PO₄)₂F₃), and the like can be used. Besides, a chalcogen compound such as a copper Chevrel phase compound (Cu₂Mo₆S₈), iron sulfide (FeS, FeS₂), cobalt sulfide (CoS), nickel sulfide (NiS, Ni₃S₂), titanium sulfide (TiS₂) or molybdenum sulfide (MoS₂), a metal oxide such as TiO₂, V₂O₅, CuO or MnO₂, C₆Cu₂FeN₆ or the like can be used.

As the anode active material contained in the anode, when the carrier is a lithium ion, for example, lithium transition metal oxides such as lithium titanate (Li₄Ti₆O₁₂) can be used. Besides, an alloy such as TiSi and La₃Ni₂Sn₇, a carbon material such as hard carbon, soft carbon or graphite, an elementary substance such as lithium, indium, aluminum, tin or silicon or alloys containing them or the like can be used.

The active material particles preferably have a spherical or ellipsoidal shape, and are preferably monodisperse. In addition, the average particle size of the active material is preferably 0.1 μm or more and 50 μm or less. When the average particle size of the active material is 0.1 μm or more, handling of the powdered active material is unlikely to become difficult. Also, when the average particle size of the active material is 50 μm or less, the tap density of the active material can be secured, and a contact property between the active material particles in the electrode can be improved. The average particle size of the active material can be obtained by observing aggregation of the active material particles by a scanning electron microscope or a transmission electron microscope and calculating an arithmetic mean of the particle size of randomly extracted 100 particles. The particle size is measured as the average of major axis diameter and minor axis diameter of the particles in an electron microscope image.

The electrode may contain other solid electrolyte used in a general all-solid-state battery, together with the solid electrolyte having deliquescence. As the solid electrolyte, a solid electrolyte that has an ion conductivity of an ion that is a carrier taking charge of battery reaction and is not allowed to deliquesce in a normal temperature range (5° C. or more and 35° C. or less) in the atmosphere is used. Particularly, it is preferable to use a solid electrolyte having high ion conductivity. It is because that battery resistance is reduced by using the solid electrolyte having high ion conductivity. It is preferred that a solid electrolyte is mixed together with an active material and a lithium vanadium oxide and used in the electrode. Whereby, an electrode in which the lithium vanadium oxide is filled in the gap between the particles of active material and solid electrolyte is formed. When the solid electrolyte is contained in the electrode, adhesion and contact property, not only between the active material particles, but also between the solid electrolyte particles and between the active material and the lithium vanadium oxide can be improved by the lithium vanadium oxide. Moreover, ion conductivity between the active material particles through the solid electrolyte is improved, and an all-solid-state battery with improved discharge capacity is obtained.

Specific examples of the solid electrolyte include oxide solid electrolytes such as perovskite-type oxides, NASICON-type oxides, LISICON-type oxides and garnet-type oxides, sulfide solid electrolytes, β-alumina, and the like. Examples of the perovskite-type oxide include Li—La—Ti perovskite-type oxides represented as LiₐLa₁₋ₐTiO₃ and the like, Li—La—Ta perovskite-type oxides represented as Li_{b}La_{1-b}TaO₃ and the like, Li—La—Nb perovskite-type oxides represented as Li_{c}La_{1-c}NbO₃ and the like, and the like (wherein 0<a<1, 0<b<1, 0<c<1). Examples of the NASICON-type oxide include oxides represented by Li₃XₙYₒPₚO_{q} containing a crystal represented by Li₁₊₁Al₁Ti₂₋₁(PO₄)₃ as an oikocryst (wherein X is at least one element selected from the group consisting of B, Al, Ga, In, C, Si, Ge, Sn, Sb and Se, Y is at least one element selected from the group consisting of Ti, Zr, Ge, In, Ga, Sn and Al, 0≦l≦1, and m, n, o, p and q are an arbitrary positive number), and the like. Examples of the LISICON-type oxide include oxides represented by Li₄XO₄—Li₃YO₄ (wherein X is at least one element selected from the group consisting of Si, Ge and Ti, and Y is at least one element selected from the group consisting of P, As and V), and the like. Examples of the garnet-type oxide include Li—La—Zr oxides represented by Li₇La₃Zr₂O₁₂, and the like. Examples of the sulfide solid electrolyte include Li₂S—P₂S₅, Li₂S—SiS₂, Li_{3.25}P_{0.25}Ge_{0.76}S₄, Li₄₋ₓGe₁₋ₓPₓS₄ (wherein 0≦r≦1), Li₇P₃S₁₁, Li₂S—SiS₂—Li₃PO₄, and the like. The sulfide solid electrolyte may be either a crystalline sulfide or an amorphous sulfide. These solid electrolytes may be one in which part of the element is replaced with other element as long as the crystal structure is similar, and may be one having a different element composition ratio. Also, as these solid electrolytes, one kind may be used alone, or a plurality of kinds may be used.

The ion conductivity of the solid electrolyte is preferably 1×10⁻⁶ S/cm or more and more preferably 1×10⁻⁴ S/cm or more. When the ion conductivity of the solid electrolyte is 1×10⁻⁶ S/cm or more, it is possible to provide the electrode with high ion conductivity by the solid electrolyte while obtaining an effect of improving a contact property between particles by a lithium vanadium oxide, by using the lithium vanadium oxide together with the solid electrolyte. It is because that the lithium vanadium oxide is inferior in crystallization as compared to the solid electrolyte, and the ion conductivity is likely to be low. The ion conductivity herein is the value at 20° C.

The electrode may contain a conductive agent used in a general all-solid-state battery. Specific examples of the conductive agent include natural graphite particles, carbon blacks such as acetylene black, Ketjen black, furnace black, thermal black and channel black, carbon fiber, metal particles of nickel, copper, silver, gold, platinum and the like or alloy particles thereof, and the like. Here, as these conductive agents, one kind may be used alone, or a plurality of kinds may be used.

The electrode may contain a binder used in a general all-solid-state battery. Specific examples of the binder include polyvinylidene fluoride (PVDF), polytetrafluoroethylene (PTFE), polyhexafluoropropylene, a styrene-butadiene rubber, an acrylonitrile-butadiene rubber, an ethylene-propylene copolymer, a styrene-ethylene-butadiene copolymer, and the like. A thickener such as carboxymethyl cellulose and xanthan gum may be also used together with the binder. Here, as these binders and thickeners, one kind may be used alone, or a plurality of kinds may be used.

### <Solid Electrolyte Layer>

The solid electrolyte layer has conductivity of a lithium ion that is a carrier taking charge of battery reaction, and is constituted so as to contain a solid electrolyte used in a general all-solid-state battery. As the solid electrolyte in the solid electrolyte layer, for example, one kind or more selected from the kinds constituting the solid electrolyte described above can be used. Here, the solid electrolyte used in the solid electrolyte layer may be the same kind as the solid electrolyte used in the electrode or may be the different kind. In the all-solid-state battery according to the present embodiment, a structure in which the lithium vanadium oxide is filled at a high density in the gap between particles of the active material constituting the electrode is formed, thus it is possible to improve adhesion and contact property between the solid electrolyte layer and the electrode and reduce interfacial resistance between layers.

In the all-solid-state battery constituted by the electrode and the solid electrolyte layer described above, each electrode of the cathode or the anode may be constituted, for example, by being laminated on a substrate such as a collector. The thickness of the electrode to be laminated can be in a proper range depending on the constitution of the electrode provided on the all-solid-state battery, and is, for example, preferably 0.1 μm or more and 1000 μm or less. Examples of the cathode collector on which the cathode is laminated include substrates and foils of stainless steel, aluminum, iron, nickel, titanium, carbon and the like. Also, examples of the anode collector on which the anode is laminated include substrates and foils of stainless steel, copper, nickel, carbon and the like.

### <Water Supply and Removal Section>

The all-solid-state battery according to the present invention has a water supply and removal section that supplies water to at least one of the cathode and the anode, and discharges water from the cathode and the anode to the outside of the battery. The water supply and removal section includes a water supply tank for supplying and retaining water, and a water supply and removal flow path that supplies water from the water supply tank to the cathode and the anode.

The water supply tank has a detachable form and has a part capable of supplying water from the outside. Therefore, the water supply tank can be detached to replenish water, and also can replenish water to a supply tank while being mounted on the all-solid-state battery.

The water supply tank and the water supply and removal flow path have an appropriate shape such as rectangular and circular shape, and are provided on the all-solid-state battery as in FIG. 1. When the water supply and removal flow path is a rectangular flow path, the practical cross-sectional area where water flows is almost circle, thus a circular shape is particularly preferable.

The materials of the water supply tank and the water supply and removal flow path may be acceptable as long as having heat resistance and strength equivalent to a battery cabinet. For example, the material is preferably aluminum and a resin, but is not particularly limited as long as satisfying the above performance.

It is desirable that an on-off valve is provided on the water supply tank and the water supply and removal flow path so that water can be optionally supplied. As a result of intensive study of the writers, it has been found that, when water is constantly supplied to the electrode without opening the on-off valve, characteristics of the all-solid-state battery are considerably degraded. Therefore, it is desirable that an on-off valve capable of optionally supplying water is provided when internal resistance of the battery is increased or the capacity is reduced due to charge/discharge cycle.

It is desirable that the on-off valves of the water supply and removal flow path and the water supply tank can be automatically or manually controlled. The on-off valve is automatically or manually controlled, whereby it is possible to operate an all-solid-state battery when the all-solid-state battery is incorporated into a system while maintaining a desired performance. The shape of the on-off valve is not particularly limited, as long as the on-off valve can supply and block water. The material of the on-off valve is preferably, for example, aluminum or a resin, but is not particularly limited.

When performance degradation of the all-solid-state battery occurs, the all-solid-state battery of the present invention can improve charge/discharge cycle characteristics by allowing a solid electrolyte having deliquescence to deliquescence again and regenerating delamination of the particle interface to restore the performance. At that time, a sensor for linking performance degradation with the on-off valve and the battery temperature is provided. The sensor is acceptable if it can link performance degradation of the all-solid-state battery with the on-off valve and the all-solid-state battery temperature, and is not particularly limited.

For example, when performance degradation is detected, the on-off valve is opened, and water is supplied from the water supply tank to the electrode. After supplying water, the electrode is dried by detecting the battery temperature and adjusting the temperature by a temperature controller.

### <Temperature Controller>

The all-solid-state battery may include a temperature controller. The temperature controller is used for removing excess water after allowing the deliquescent solid electrolyte to deliquesce. In the all-solid-state battery of the present invention, the solid electrolyte having deliquescence filled in the electrode can optionally be allowed to deliquesce again and dried. The temperature to allow the solid electrolyte to deliquesce again should be 0° C. or more. Also, the temperature to dry the solid electrolyte is preferably from 0° C. to 200° C. At 0° C. or less, water is frozen and hard to be dried, and at 200° C. or more, it is possible to have an adverse effect on an electronic circuit of the system incorporating the all-solid-state battery. Therefore, it is more preferable to allow the solid electrolyte to deliquesce again and dry it at 0° C. to 150° C.

When charge and discharge are performed with the solid electrolyte allowed to deliquesce without removing excess water after being allowed to deliquesce, resistance is increased by the influence of water. Therefore, after allowing the solid electrolyte to deliquesce, it is necessary to remove excess water.

The temperature control of the all-solid-state battery may be controlled by system incorporating the all-solid-state battery itself, or a temperature controller may be provided on the all-solid-state battery itself. The temperature controller has a function capable of optionally heating and cooling the all-solid-state battery. Examples of the temperature controller include an incubator and the like.

<Method for Restoring Capacity of all-Solid-State Battery>

In the electrode for an all-solid-state battery according to the present embodiment, the electron conductivity between the active material particles is significantly improved by the lithium vanadium oxide filled between the active material particles. Thus, the electrode for an all-solid-state battery according to the present embodiment has low internal resistance, and is useful in the all-solid-state battery having high discharge capacity. In addition, even though once the active material and the solid electrolyte or the active material and the active material particles cause interfacial delamination with charge/discharge cycle, the lithium vanadium oxide having deliquescence by water from the water supply tank and the water supply and removal flow path of the all-solid-state battery of the present invention is allowed to deliquesce again and dried, thereby regenerating the interface and restoring charge/discharge characteristics, thus charge/discharge cycle characteristics are improved. In this case, since battery deterioration is caused by remaining of water in the battery, it is preferable to be dried by heat treatment after joining the electrode and the solid electrolyte layer.

In order to restore the capacity of the all-solid-state battery according to the present invention, water is supplied to the electrode from the water supply and removal section, thereby allowing a solid electrolyte having deliquescence to deliquesce again and regenerating delamination of the particle interface. After regenerating delamination of the particle interface, excess water is removed from the electrode to the outside of the battery via the water supply and removal section in order to dry the electrode. A temperature detecting section and a temperature controller are equipped with the all-solid-state battery, and the battery temperature is detected by the temperature detecting section, then the electrode may be dried by driving the temperature controller based on the detected temperature.

<Production Method of all-Solid-State Battery>

The method for producing an all-solid-state battery according to the present embodiment mainly includes an electrode mixture preparation step of preparing an electrode mixture, an electrode production step of heat treating and forming the electrode mixture to prepare an electrode, a joining step of joining the electrode and the solid electrolyte layer, and an incorporating step of incorporating the prepared electrode into the battery cabinet.

In the electrode mixture preparation step, a solid electrolyte having deliquescence is allowed to deliquesce, and the solid electrolyte having deliquescence is mixed with an active material to prepare an electrode mixture. The solid electrolyte having deliquescence may be allowed to deliquesce in a normal temperature range in the atmosphere. The solid electrolyte having deliquescence is reacted with water in the atmosphere in such an atmosphere, thereby completely dissolving the solid electrolyte having deliquescence, and is allowed to deliquesce until it is substantially balanced with the atmosphere where the step is carried out. The solid electrolyte having deliquescence is allowed to deliquesce as described above, whereby flowability suitable for forming an electrode having high adhesion of the active material particles can be obtained. In addition, water concentration is not excessively high, and the solid electrolyte having deliquescence is hard to be made as an aqueous solution, thus it is likely to form a structure in which high density solid electrolyte is filled in the gap between the active material particles constituting the electrode, and a contact property between the active material particles, specifically ion conductivity and electron conductivity, is improved. Here, the humidity of the atmosphere where the solid electrolyte is allowed to deliquesce is not particularly limited, and when the humidity is low, water in an amount that it is not balanced with the atmosphere where the step is carried out may be externally added.

The solid electrolyte having deliquescence is allowed to deliquesce, then the active material is added to the dissolved solid electrolyte having deliquescence, and these are mixed and homogenized to prepare an electrode mixture. At this time, other solid electrolyte contained in the electrode and a conductive agent are added, and can be mixed therewith. The dry weight of the solid electrolyte having deliquescence to be mixed is preferably 5 parts by weight or more and 50 parts by weight or less, based on the total dry weight of the solid electrolyte having deliquescence, other solid electrolyte and the active material. When the solid electrolyte having deliquescence in such an amount is mixed, an all-solid-state battery having low internal resistance, favorable volume energy density and high discharge capacity can be produced. Also, a binder can be added together with a solvent. As the solvent, water, N-methylpyrrolidone, N,N-dimethylformamide, N,N-dimethylacetamide, methanol, ethanol, propanol, ethylene glycol, glycerol, dimethyl sulfoxide, tetrahydrofuran or the like can be used, depending on the kind of the solid electrolyte and the binder. The lithium vanadium oxide allowed to deliquesce has an action of binding particles, thus these binders and solvents may not be added. For mixing for preparing an electrode mixture, for example, a high-viscosity mixing means such as a homomixer, a disperser mixer, a planetary mixer or a rotating and revolving mixer can be used.

In the electrode production step, the prepared electrode mixture is heat-treated and then formed to produce an electrode. The heat treatment may be performed in any of an active gas atmosphere such as air and an inert gas atmosphere such as a nitrogen gas or an argon gas. Also, the used gas type may be one type alone or in combination of two or more types. Water dissolving the solid electrolyte having deliquescence is evaporated by heat-treating the electrode mixture, and crystal of the solid electrolyte oxide having deliquescence is precipitated around the active material particles, thus it is possible to form a matrix structure in which the high density solid electrolyte is filled in the gap between the active material particles. Therefore, a contact property between the active material particles through the solid electrolyte particles, specifically, ion conductivity, is improved.

The heating temperature in the heat treatment can be set at an appropriate temperature depending on the composition of the electrode mixture, and is preferably 15° C. or more and 650° C. or less, and more preferably 100° C. or more and 300° C. or less. When a lithium vanadium oxide is used as the solid electrolyte having deliquescence, at a heating temperature of 15° C. or more, water contained in the lithium vanadium oxide can be favorably evaporated in the atmosphere, and dried and removed. Also, at a heating temperature of 650° C. or less, a solid phase reaction of the electrode active material and the solid electrolyte can be prevented, thus generation of a different phase having a low ion conductivity is prevented, and increase in internal resistance can be suppressed. Particularly, at a heating temperature of 100° C. or more and 300° C. or less, water contained in the lithium vanadium oxide can be sufficiently eliminated to form an electrode showing high capacity while avoiding increase in internal resistance.

The heat-treated electrode mixture is formed as an electrode. The shape to be formed can be a proper shape depending on the form of the all-solid-state battery, and can be, for example, a rectangular plate shape, a disk shape, or the like. In the formation, for example, a pressure forming at about 5 MPa or more and 200 MPa or less can be performed, and it is preferable not to involve cracking of the electrode mixture since a grain boundary is generated. The electrode composed of the electrode mixture may be joined with a collector to form an electrode for an all-solid-state battery. When joined with a collector, the above electrode mixture is coated on the collector and then subjected to a heat treatment, and the electrode is fused with the collector to produce a electrode for an all-solid-state battery. For the coating of the electrode mixture, for example, a wet application means such as a roll coater, a bar coater or a doctor blade can be used.

In the joining step, the produced electrode is joined with the other electrode constituting a pair, so as to interpose the solid electrolyte layer between the electrodes. More specifically, when the cathode is produced using a lithium vanadium oxide, this cathode is pressure-bonded with one surface of the solid electrolyte layer, in a disposition so as to interpose the solid electrolyte layer between the cathode and the anode, and when the anode is produced using a lithium vanadium oxide, this anode is pressure-bonded with one surface of the solid electrolyte layer, in a disposition so as to interpose the solid electrolyte layer between the anode and the cathode. Alternatively, when both the cathode and the anode are produced using a lithium vanadium oxide, the cathode is pressure-bonded with one surface of the solid electrolyte layer, and the anode is pressure-bonded with the other surface, in a disposition so as to interpose the solid electrolyte layer between these cathode and anode. An output terminal for extracting an electric power from the all-solid-state battery is connected to an electrode assembly in which the electrode and the solid electrolyte layer are connected, as necessary. The output terminal may be made of, for example, aluminum having voltage resistance or the like, and provided by welding to the collector or the like.

In the incorporating step, an insulating material is interposed in the produced electrode assembly, and the resulting electrode is filled in an outer package to form an all-solid-state battery.

In the all-solid-state battery produced as described above, it is possible to form an all solid primary battery irreversibly performing discharge or an all solid secondary battery reversibly performing charge and discharge, by properly selecting the constitution of the electrode and active material. Particularly, the all solid secondary battery is useful as a power source of a household or industrial electrical appliance, a mobile information communication device, a storage system, a ship, a railway, an aircraft, a hybrid automobile, an electric automobile or the like. Also, the structure of the all-solid-state battery can be visually confirmed by disassembly, and the composition and structures of the electrode and the solid electrolyte layer can be confirmed by X-ray photoelectron spectroscopy, inductively coupled plasma emission spectrometric analysis, fluorescence X-ray analysis or X-ray diffraction analysis.

Next, the present invention will be specifically described with reference to examples of the present invention, and the technical scope of the present invention is not limited thereto.

An all-solid-state battery was produced based on the following examples, and the change of the discharge capacity thereof in the charge/discharge cycle was evaluated. At that time, when the discharge capacity is lowered to 30% based on the initial discharge capacity, water was supplied to the electrode and removed by drying. Here, water supply and removal were not conducted as to the comparative examples.

### Example 1

As Example 1, an electrode assembly produced according to the following procedure was incorporated in an outer package of an all-solid-state battery provided with water supply tank 3A and cathode side and anode side water supply and removal flow paths 3B and 3C in FIG. 1 to produce an all-solid-state battery.

First, 1.85 g of lithium carbonate (Li₂CO₃) and 4.55 g of divanadium pentoxide (V₂O₅) were weighed and put in a mortar, and the ingredients were mixed to be uniform. Subsequently, the resulting mixture was transferred to a quartz boat with an outer diameter of 10 mm, and heat-treated in a tubular electric furnace. The heat treatment herein was a treatment of raising the temperature to 800° C. at a heating rate of 10° C./min in a hydrogen gas atmosphere and then maintaining the temperature at 800° C. for 3 hours. Moreover, after the heat treatment, the mixture was cooled to 100° C. to obtain a lithium vanadium oxide.

Subsequently, the resulting lithium vanadium oxide was weighed so as to be 30% by mass per a dry weight of the electrode, and all of them were allowed to deliquesce in the atmosphere. Moreover, LiCoO₂ particles, which are a cathode active material, were added to the lithium vanadium oxide allowed to deliquesce, and the ingredients were mixed to be uniform to prepare an electrode mixture. Subsequently, the resulting electrode mixture was coated on the aluminum foil collector and subjected to a heat treatment at 100° C. for 2 hours to remove water, and then punched into a disk shape with a cross-sectional area of 1 cm² to obtain a cathode.

On the other hand, a lithium foil and a copper foil were press-bonded and punched into a disk shape with a cross-sectional area of 1 cm² to obtain an anode. In addition, a PEO solid polymer film was used in the solid electrolyte layer. The cathode, the anode and the solid electrolyte layer were stacked so as to interpose the solid electrolyte layer between them and pressurized at a pressure of 10 MPa for 1 minute to prepare an electrode assembly. Moreover, both ends of the cathode side and anode side of the electrode assembly were interposed by a separator made of an insulating material, and further interposed by an outer package provided with water supply tank 3A and cathode side and anode side water supply and removal flow paths 3B and 3C from the outside thereof, and caulked by a torque of 15 N/m to produce an all-solid-state battery according to Example 1.

### Example 2

In Example 2, a bipolar all-solid-state battery as in FIG. 2 was produced. The all-solid-state battery in FIG. 2 includes a bipolar electrode assembly and a water supply and removal section. In FIG. 2, the water supply and removal section includes a water removal port 5, a water supply layer 11, and a drain 12. The electrode assembly has a cathode 7, an anode 9, and a solid electrolyte layer 8. The cathode 7, the anode 9 and the solid electrolyte layer 8 are laminated so as to interpose the solid electrolyte layer 8 between the cathode 7 and the anode 9 to form a laminate. The cathode 7 and the anode 9 are each provided with porous collector 6, and collector 10 is interposed between the porous collectors provided in the cathode 7 and the anode 9 to obtain a bipolar electrode assembly when stacking one laminate. The electrode assembly in which four cells composed of the cathode, the solid electrolyte layer and the anode were connected in series was incorporated in an outer package provided with the water supply and removal section to produce a bipolar all-solid-state battery.

### Example 3

As Example 3, an all-solid-state battery was produced in the same manner as in Example 1, except for connecting four laminated electrode assemblies in parallel in Example 2.

### Comparative Example 1

As Comparative Example 1, an all-solid-state battery was produced in the same manner as in Example 1, except for producing an all-solid-state battery by incorporating the electrode assembly in Example 1 into a SUS outer package in which water supply tank 3A and cathode side and anode side water supply and removal flow paths 3B and 3C were not provided.

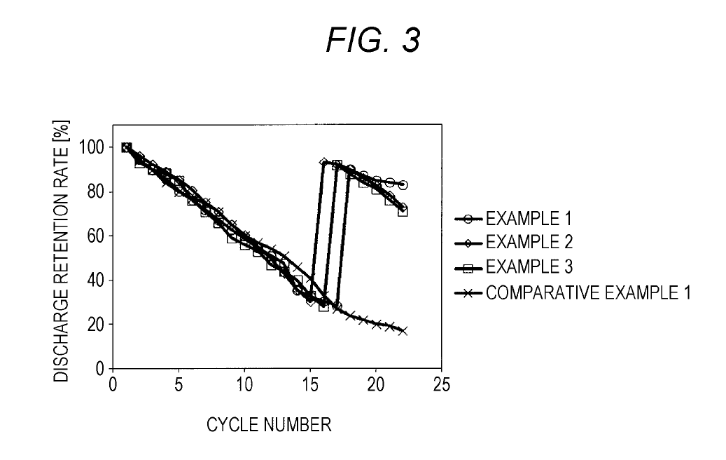

The measurement of discharge capacity of the battery according to the produced Examples 1 to 3 and Comparative Example 1 was performed by first charging the battery up to a termination voltage of 4.25 V with a constant current at 25° C., and pausing, then discharging the battery up to a termination voltage of 3.0 V with a constant current. Further, after discharge, and after pause, the above charge and discharge were repeated to evaluate charge/discharge cycle characteristics. Here, in Examples 1 to 3, when the discharge capacity is lowered to 30% based on the initial discharge capacity, water was supplied to the electrode and removed by drying, during a pause after discharge. The evaluation result of charge/discharge cycle characteristics is shown in FIG. 3.

In FIG. 3, the vertical axis shows a discharge capacity retention rate based on the initial discharge capacity, and the horizontal axis shows a charge and discharge cycle number. As shown in FIG. 3, it could be confirmed that, in the all solid batteries according to Examples 1 to 3, the discharge capacity was restored and charge/discharge cycle characteristics were improved by supplying water to the electrode and removing water by drying, as compared to Comparative Example 1 in which water was not supplied to the electrode and removed by drying. It was confirmed based on this result that generally required performance can be fully achieved by repeating the supply of water to the electrode and removal of water by drying. An all-solid-state battery in which the electrode contains a solid electrolyte having deliquescence, including a water supply and removal section that supplies water to the electrode and can discharge water in the electrode to the outside of the battery was used, whereby water could be easily supplied to the electrode, and then excess water could be removed by drying. As a result, it became possible to reproduce the interface delaminated in the electrode, thus the battery capacity could be restored, and charge/discharge cycle characteristics were improved.

What is claimed is:

1. An all-solid-state battery comprising:
a cathode;
an anode; and
a solid electrolyte layer disposed between the cathode and the anode, wherein
at least one of the cathode and the anode contains a solid electrolyte having deliquescence, and
a water supply and removal section that supplies water to an electrode containing the solid electrolyte having deliquescence and removes water from the electrode.

2. The all-solid-state battery according to claim 1, wherein the water supply and removal section includes a water supply tank for retaining water, a water supply and removal flow path, and an on-off valve provided in at least one of the water supply and removal flow path and the water supply layer.

3. The all-solid-state battery according to claim 2, wherein the on-off valve opens and closes linked with at least one of the battery temperature and the battery capacity.

4. The all-solid-state battery according to claim 1, comprising a temperature controller.

5. The all-solid-state battery according to claim 1, wherein the solid electrolyte having deliquescence is a vanadium oxide.

6. The all-solid-state battery according to claim 5, wherein the vanadium oxide is a lithium vanadium oxide.

7. The all-solid-state battery according to claim 1, wherein at least one of the cathode and the anode contains a solid electrolyte without having deliquescence.

8. The all-solid-state battery according to claim 7, wherein the content of the solid electrolyte having deliquescence in the electrode is 5 parts by mass or more and 50 parts by mass or less, based on the dry total weight of the solid electrolyte having deliquescence, the solid electrolyte without having deliquescence and the electrode active material.

9. A method for restoring battery capacity of the all-solid-state battery according to claim 1, wherein
the solid electrolyte having deliquescence is allowed to deliquesce by supplying water to the electrode from the water supply and removal section and then the water of the electrode is removed via the water supply and removal section.

10. A method for restoring battery capacity of the all-solid-state battery according to claim 4, wherein
the all-solid-state battery includes a temperature detection section, and
the solid electrolyte having deliquescence is allowed to deliquesce by supplying water to the electrode from the water supply and removal section, then the battery temperature is detected at the temperature detection section, and the water of the electrode is removed via the water supply and removal section by driving the temperature controller based on the detected battery temperature.

11. A method for producing an all-solid-state battery comprising:
a cathode containing a cathode active material;
an anode containing an anode active material; and
a solid electrolyte layer disposed between the cathode and the anode, wherein
at least one of the cathode and the anode contains a solid electrolyte having deliquescence, and
the all-solid-state battery includes a water supply and removal section that supplies water to an electrode containing the solid electrolyte having deliquescence and removes water from the electrode, and the method comprises:
preparing an electrode mixture by allowing the solid electrolyte having deliquescence to deliquesce and then mixing with an electrode active material; and
producing an electrode by heat treating the electrode mixture.

12. The method for producing an all-solid-state battery according to claim 11, wherein the content of the solid electrolyte having deliquescence in the electrode mixture is 5 parts by mass or more and 50 parts by mass or less, based on the dry total weight of the solid electrolyte and the electrode active material.

13. The method for producing an all-solid-state battery according to claim 11, wherein
the heating temperature in the heat treatment when producing the electrode is 100° C. or more and 300° C. or less.

14. The method for producing an all-solid-state battery according to claim 11, wherein the solid electrolyte having deliquescence is a lithium vanadium oxide.
